(19) United States
(12) Patent Application Publication
(10) Pub. No.: US 2026/0188939 A1
(43) Pub. Date: Jul. 2, 2026

(54) ELECTRICAL CONNECTOR

(71) Applicant: JAGUAR LAND ROVER LIMITED, Warwickshire (GB)

(72) Inventor: Inaki BARROSO, Whitley, Coventry, Warwickshire (GB)

(21) Appl. No.: 19/130,977

(22) PCT Filed: Nov. 15, 2023
(86) PCT No.: PCT/EP2023/081927

§ 371 Date: May 19, 2025

(30) Foreign Application Priority Data
Nov. 29, 2022 (GB) 2217871.9

(51) Int. Cl. H01R 13/52

(52) U.S. Cl. CPC H01R 13/5202; H01R 13/5213; H01R 2201/26

(57) ABSTRACT

The present invention relates to an electrical connector (100) for engagement with a complementary connector (200). The electrical connector comprises a first terminal (102); an enclosure (104) surrounding the first terminal; a probe access port (106) extending between an outer surface of the enclosure and the first terminal; and a conductive body (108) disposed within the probe access port and moveable between a first position in which the conductive body is in electrical connection with the first terminal and a second position in which the conductive body is electrically disconnected from the first terminal, wherein the conductive body is biased towards the second position.

### TECHNICAL FIELD

The present disclosure relates to electrical connector. Aspects of the invention relate to electrical connector, to a wiring harness, and to a vehicle.

### BACKGROUND

It is known to provide an electrical connector suitable for engagement with a complementary connector, to allow an electrical signal in the form a voltage or current to be transmitted between the connectors. Such an electrical signal may be suitable for transmitting power and/or data. On occasion, issues may arise while the connection is in use. A user may wish to examine the terminal and assess any signal present at the terminal. Accessing the terminal requires that the connection between the connectors be broken. However, by disconnecting the connectors, the signal may change and/or the issue or relevant evidence of the issue may no longer be present.

It is an aim of the present invention to address one or more of the disadvantages associated with the prior art.

### SUMMARY OF THE INVENTION

Aspects and embodiments of the invention provide an electrical connector, a wiring harness, and a vehicle as claimed in the appended claims.

According to an aspect of the present invention there is provided an electrical connector for engagement with a complementary connector, the electrical connector comprising an a conductive body disposed within a probe access port and moveable between a first position in which the conductive body is in electrical connection with a terminal and a second position in which the conductive body is electrically disconnected from the a terminal, wherein the conductive body is biased towards the second position. In this way, the signals within the connector may be assessed via the probe access port while the electrical connector is connected to a complementary connector.

According to an aspect of the present invention there is provided electrical connector for engagement with a complementary connector, the electrical connector comprising: a first terminal; an enclosure surrounding the first terminal; a probe access port extending between an outer surface of the enclosure and the first terminal; a conductive body disposed within the probe access port and moveable between a first position in which the conductive body is in electrical connection with the first terminal and a second position in which the conductive body is electrically disconnected from the first terminal, wherein the conductive body is biased towards the second position. In this way, a user such as mechanic may use a suitable probe to access the terminal of the electrical connector and assess the electrical signal present at that terminal while the electrical connector is connected to the complementary connector. As such, the electrical connector provides for improved diagnostics on products comprising the electrical connector, allowing more problems to be correctly identified and corrected.

In an embodiment, the electrical connector comprises a seal disposed between the conductive body and the probe access port for preventing passage of liquid through the probing access port. In this way, the probe access port is waterproof and facilitates the electrical connector being waterproof.

The probe access port comprises a plurality of seals. This allows for robust waterproof operation of the probe access port.

Optionally, the electrical connector may comprise a biasing mechanism configured to bias the conductive body in the second position. This is an efficient manner of providing for the conductive body to be biased towards the second position. The electrical connector does not necessarily comprise any biasing mechanism. The conductive body may be biased in the second position by means other than any biasing mechanism. For example, the conductive body and/or the probe access port may comprise structural and/or material properties that cause the conductive body to be biased towards the second position.

The conductive body may comprise an engagement component to engage the biasing mechanism. This is an efficient way to implement a biasing mechanism.

In an embodiment, the electrical connector comprises a cap to cover the probe access port at the outer surface of the enclosure. In this way, the interior of the probe access port can be protected until it is desired to probe the terminal. The cap may be biased into a closed position.

Optionally, the conductive body may comprise a proximal end adjacent the terminal and a distal end adjacent a probe-receiving aperture in the probe access port. A first seal may be positioned adjacent the distal end of the conductive body and a second seal is positioned adjacent the proximal end of the conductive body. This is a useful an efficient manner of positioning the seals to provide robust waterproofing.

According to an aspect of the present invention there is also provided an electrical connection between an electrical connector as defined above and a second electrical connector that comprises a second connector terminal which is in electrical contact with the first terminal, wherein said electrical connection of the conductive body with the first terminal is through contact of the conductive body with the second connector terminal. Optionally, it may be that the conductive body is such that it cannot make electrical connection with the first terminal except via the second connector terminal.

In an embodiment, the electrical connector comprises a plurality of terminals, each one having its own probe access port. In this way, the connector may be used to form connections for multiple signals.

According to another aspect of the present invention there is provided a wiring harness comprising a connector as described herein. In this way, there is provided a wiring harness and connector having a plurality of terminals, each of which may be probed to assess the current or voltage present at the relevant terminal. Use of the electrical connector of the disclosure with a wiring harness is particularly advantageous as diagnosing a problem in one connection without the probe access port would be difficult. Accessing a single terminal may require disconnecting the full multi-terminal connector. This is inconvenient and may interfere with assessing and/or diagnosing any issue.

According to a further aspect of the invention, there is provided a vehicle comprising an electrical connector or a wiring harness as described herein. Vehicles may comprises many connectors and wiring harnesses, thus being able to access and measure the signals within the connectors is useful.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1(a) shows a block diagram of a cross-section of an electrical connector, with the conductive body in a first position according to an embodiment of the invention;

FIG. 1(b) shows a block diagram of a cross-section of the electrical connector of FIG. 1(a), with the conductive body in a second position according to an embodiment of the invention;

FIG. 2(a) shows a block diagram of a cross-section of the electrical connector of FIG. 1, with a complementary connector adjacent thereto;

FIG. 2(b) shows a block diagram of a cross-section of the electrical connector of FIG. 1, engaged with the complementary connector;

FIG. 3(a) shows a block diagram of a cross-section of an electrical connector, with the conductive body in a first position and an open cap, according to an embodiment of the invention;

FIG. 3(b) shows a block diagram of a cross-section of the electrical connector of FIG. 3(a), with the conductive body in a second position and a closed cap, according to an embodiment of the invention;

FIG. 4 shows a block diagram of a cross-section of an electrical connector, with the conductive body in its second position and an open cap, according to an embodiment of the invention;

FIG. 5 shows a block diagram of a cross section of a multiple electrical connector, according to an embodiment of the invention;

FIG. 6 shows a wiring harness according to an embodiment of the invention; and

FIG. 7 shows a vehicle in accordance with an embodiment of the invention.

### DETAILED DESCRIPTION

The present invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

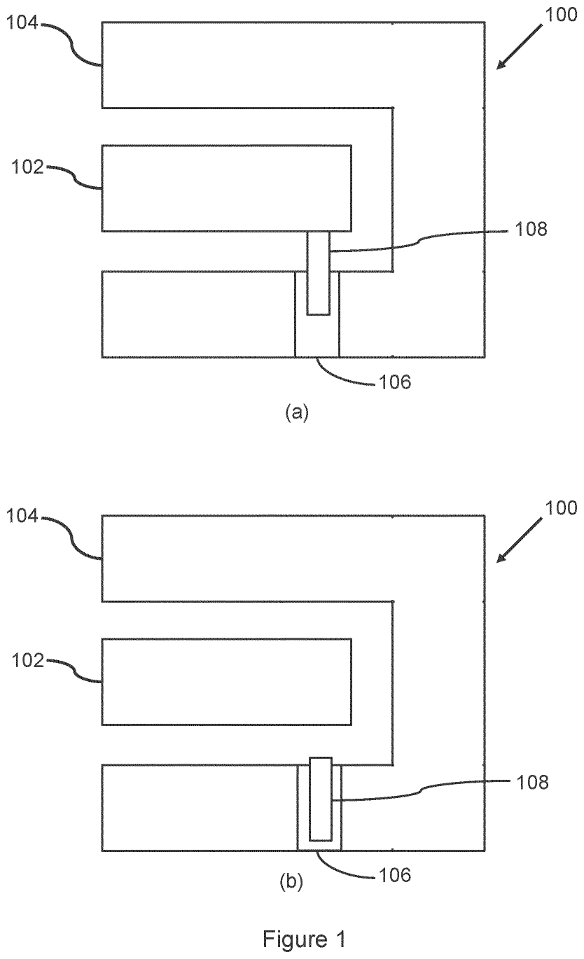

Referring to FIGS. 1(a) and 1(b), there is shown an electrical connector, indicated generally by the reference numeral 100. The electrical connector 100 is suitable for engagement with a complementary connector. The electrical connector 100 comprises a first terminal 102 and an enclosure 104 surrounding the terminal 102. The electrical connector 100 comprises a probe access port 106 extending between an outer surface of the enclosure 104 and the first terminal 102. A conductive body 108 is disposed within the probe access port 106. The conductive body 108 is moveable between a first position, as shown in FIG. 1(a), in which the conductive body 108 is in electrical connection with the first terminal 102 and a second position, as shown in FIG. 1(b), in which the conductive body is electrically disconnected from the first terminal 102. The conductive body 108 is biased towards the second position. As such, the conductive probe 108 will by default not be in contact with the terminal 102.

The probe access port 106 is shown to be located in a side of the enclosure 104 such that the conductive body 108 is positioned orthogonally to the terminal 102. It will be understood that the invention is not limited to this arrangement and other arrangements are possible, for example, the probe access port 106 may be located at a rear of the enclosure 104, the conductive body 108 may be at a different angle in relation to the terminal and so on.

The conductive body 108 may have a number of suitable shapes. It may be an elongate shape such as a pin, bolt or the like, having a circular, square, rectangular or other suitable cross-section, and may have a more complicated cross-section, such as a H-shape, I-shape or the like. However, the conductive body is not limited to these shapes, as will be apparent to the person skilled in the art.

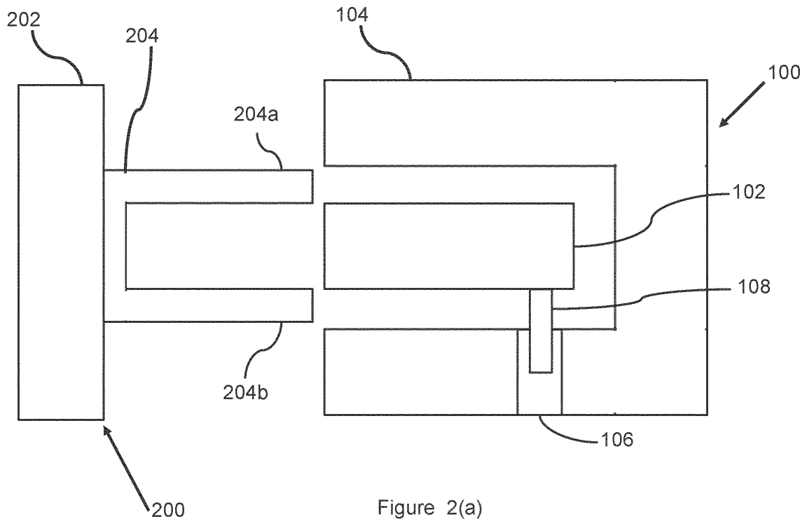

Referring to FIGS. 2(a) and 1(b), there is shown the electrical connector 100, and a complementary connector 200. The complementary connector 200 comprises a base 202 and a complementary terminal 204. The complementary terminal 204 is U-shaped, having two prongs 204a, 204b. In use, as shown in FIG. 2(b), the connector 100 and the complementary connector 200 can be brought into engagement such that the terminal 102 engages the complementary terminal 204, forming an electrical connection therebetween.

A user may wish to measure the electrical signal transmitted through the connectors 100, 200 while they are forming the electrical connection, as this this can provide useful information, such as diagnostic information if there is a malfunction or an undesirable outcome with the components involved. In such case, disconnecting the connector 100 and complementary connector 200 may be unhelpful as then there is no longer any electrical connection and no electrical signals being transmitted. As such, a user may wish to contact one of the terminals 102 or complementary terminal 204, without disconnecting the connector 100 and complementary connector 200.

In use, a conductive probe (not shown) is inserted into the probe access port 106 to make contact with the conductive body 108. Applying pressure to the probe can be used to move the conductive body 108 from its second position, shown in FIG. 1(b), to its first position, shown in FIG. 1(a). In the second position, the conductive body 108 is electrically disconnected from the first terminal 102. In the first position, the conductive body 108 is engaging the first terminal 102 and is in electrical connection with the terminal 102. As such, using a probe in the probe access port 106 to move the conductive body 108 into contact with the terminal 102 places the probe into electrical connection with the terminal 102. If the connector 100 and complementary connector 200 are connected, the probe in the probe access port 106, with the conductive body 108 in its first position in contact with the terminal 102, is in electrical connection with both the terminal 102 and complementary terminal 204. In this way, the probe may measure any electrical signals passing between the connector 100 and complementary connector 200.

While the connector 100 comprising the probe access port 106 and the conductive body 108 is shown as a female connector, it will be understood that this is not essential, and the probe access port 106, conductive body 108 may be in a male connector, or other connector type. Furthermore, while it is described above that the conductive body makes contact with the first terminal when in the first position of the conductive body, when the second connector terminal is engaged with the first terminal, it may be arranged that the conductive body contacts the second connector terminal when in the first position. That is, the invention anticipates an electrical connection between an electrical connector as described above and a second electrical connector. Here, second electrical connector comprises a second connector terminal 204a, 204b which is in electrical contact with the first terminal 102. However, the electrical connection of the conductive body 108 with the first terminal 102 is instead through contact of the conductive body with the second connector terminal 204. This alternative is not shown in the drawings. Indeed, it may be that the conductive body 108 is such that it cannot make electrical connection with the first terminal except via the second connector terminal. For example, it may not be long enough to reach the first terminal directly and can only make electrical contact with it by contacting the second connector terminal when that is engaged with the first terminal.

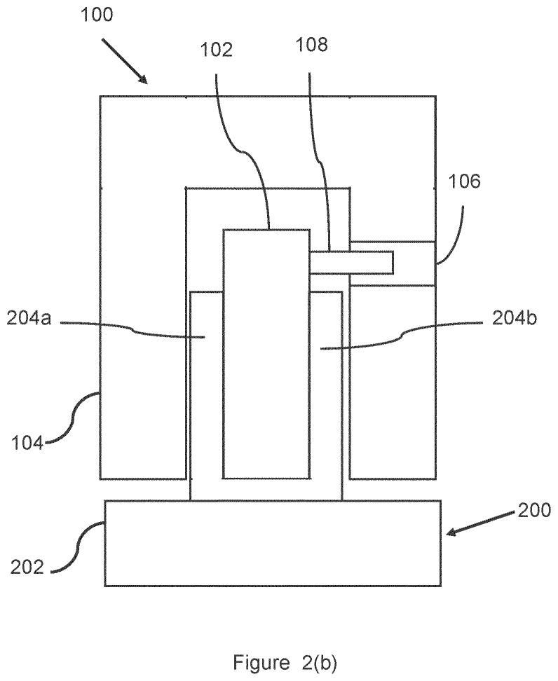

Referring now to FIGS. 3(a) and (b), there is shown the connector 100 wherein the probe access port 106 is fitted with a slideable cap 302 to cover the opening of the probe access port 106. The opening may be referred to as a probe-receiving aperture. As shown in FIG. 3(b), when the conductive body 108 is in the second position where conductive body is electrically disconnected from the first terminal, the cap 302 is in a closed position blocking access to the probe access port 106. As shown in FIG. 3(a), when the conductive body 108 is in the first position where conductive body is in electrical connection with the first terminal, the cap 302 is slid to the side to allow access to the probe access port 106. It will be understood that the cap is not required to be slideable. Any suitable cap that can close the aperture of the probe access port 106 may be used. The cap 302 may be biased into the closed position. It may be that sliding or otherwise opening the cap 302 may be arranged to cause the conductive body 108 to move from the second position to the first position. And vice versa when the cap is closed. Alternatively, as described above, it may be that a probe inserted into the probe access port 106, once the cap 302 is opened, contacts the conductive body 108 and causes it to move to the first position.

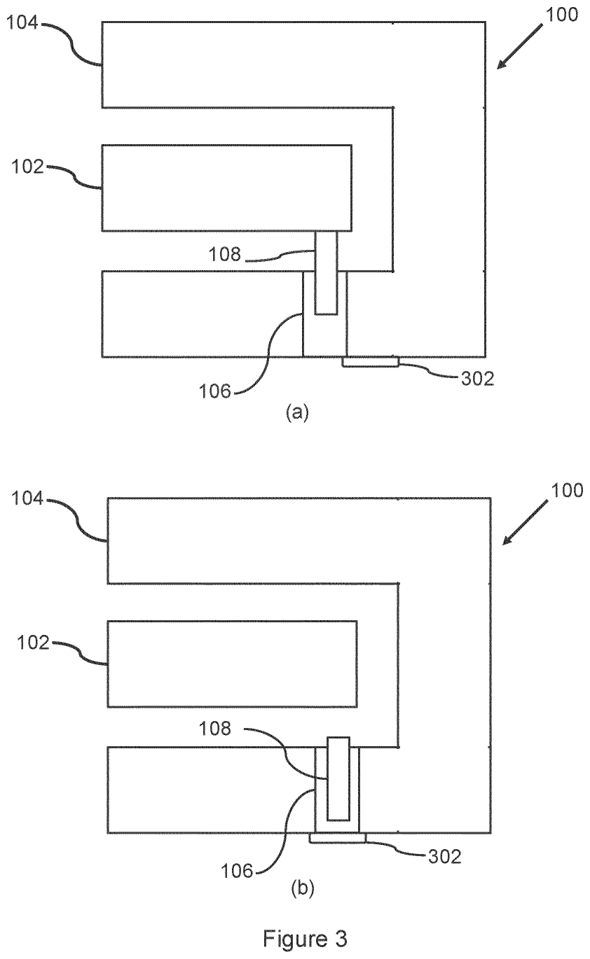

Referring now to FIG. 4, there is shown a cross-section of portion of a connector 100 according to an embodiment of the invention, wherein the connector is suitable for use as a waterproof connector. The connector 100 comprises the terminal 102, enclosure 104, probe access port 106, and cap 302 as described herein in relation to previous figures. A waterproof connector may comprise one or more seals disposed between the conductive body and the probe access port for preventing passage of liquid through the probe access port 106. In FIG. 4, the conductive body 108 has a pair of seals 402a, 402b encircling the conductive body 108. The seals 402a, 402b extend between the conductive body 108 and the probe access port 106, abutting against each. The pair of seals 402a, 402b are spaced apart. The first seal 402a is located adjacent the open aperture of the enclosure 104 of the probe access port 106. The second seal 402b is located at another end of the probe access port 106, adjacent to the terminal. The end of the of the probe access port 106 and conductive body 108 near the terminal may be referred to as the proximal end, while the end near the opening in the enclosure adjacent the cap 302 may be referred to as the distal end. The seals used may be chosen to provide protection meeting the IP68 and IPX9K water ingress standards.

The seals used in the implementation of a waterproof connector are not limited in size, shape or position by what is shown in FIG. 4. The seals may be part of the connector enclosure 104 or may be part of the conductive body 108. The seals may be provided, for example, inserted into dedicated grooves, formed via bi-material injection, or from additional components such as caps. Typically, the seals would be formed from silicone, but other suitable materials will be apparent to the person skilled in the art.

FIG. 4 also shows an example of a biasing mechanism for the conductive body 108. The conductive body 108 for use with the biasing mechanism as shown an engagement component in the form of a flange 404, such that the illustrated conductive body 108 has a substantially cruciform cross-section. The biasing mechanism is configured to bias the conductive body towards the second position. The flange projects orthogonally from the conductive body 108, but other arrangements of engagement component are possible. The flange 404 engages first ends of a pair of biasing helical springs 406a, 406b, where another end of the springs 406a, 406b engages the inside of the probe access port 106. Advancing the conductive body 108 from the second position to the first portion to contact the terminal 102 results in the springs 406a, 406b being compressed. As such, once the force causing the advancement of the conductive body 108 is removed, the springs 406a, 406b expand again, withdrawing the conductive 108 back to its second position away from the contact with the terminal 102. This biasing mechanism comprising the engagement component in the form of the flange 404 and springs 406a, 406b is understood to be an example of a suitable biasing mechanism. The biasing mechanism of the invention is not limited to this implementation and other suitable biasing mechanisms may be used, as will be apparent to the person skilled in the art. For example, a flexible component such as a spring could be located inside the conductive body 108, or a formed as part of the enclosure 104.

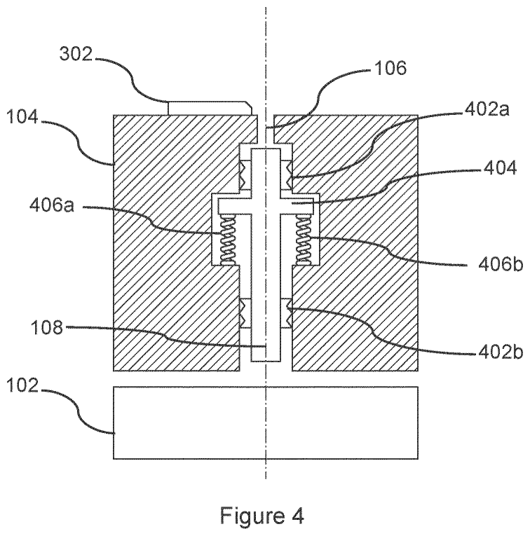

Referring now to FIG. 5, there is shown a cross-section of a multiple connector, indicated generally by the reference numeral 500. The multiple connecter 500 comprises a plurality of terminals, each one having its own probe access port. FIG. 5 shows a multiple connector 500 comprising an enclosure 504, a plurality of terminals 102a, 102b, 102c, 102d, and a probe access port 106a, 06b, 106c, 106d associated with each terminal 102a, 102b, 102c, 102d. The enclosure 504 comprises a number of portions separating the terminals from each other. In the multiple connector 500 shown in FIG. 5, the probe access ports 106a, 06b, 106c, 106d are located at the rear of each terminal to provide access. A multiple connector 500 may comprise a single row of individual connectors, or may comprise multiple rows to form a 2D array of individual connectors. It will be understood that the multiple connector described herein in relation to FIG. 5 is an example of a multiple connector and further arrangements comprising a plurality of terminals, each one having its own probe access port are within the scope of the disclosure.

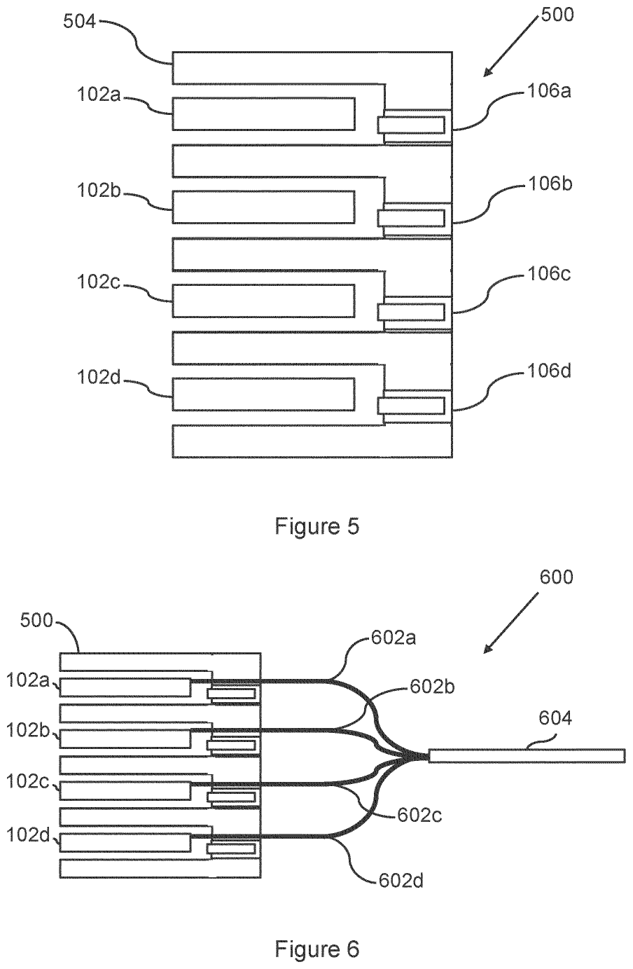

Referring now to FIG. 6, there is shown a block diagram of a wiring harness, indicated generally by the reference numeral 600, comprising the multiple connector 500 described herein in relation to FIG. 5. The multiple connector 500 comprises four terminals 102a, 102b, 102c, 102d, each connected to a wire 602a, 602b, 602c, 602d. The wires 602a, 602b, 602c, 602d are bound together to form a single cable 604 forming part of the wiring harness 600.

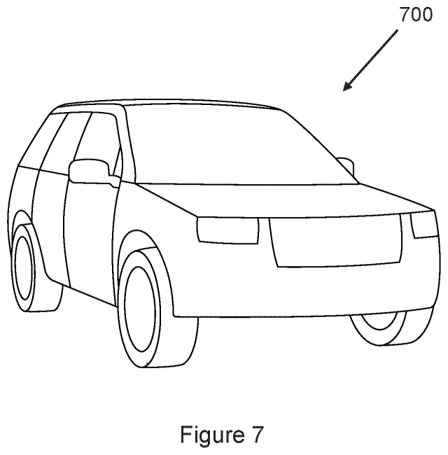

FIG. 7 illustrates a vehicle 700 according to an embodiment of the present invention. The vehicle 700 comprises a connector 100 as described herein. The vehicle 700 comprises a wiring harness 600 as described herein.

Throughout the specification, the term electrical signal may be understood to refer to a power signal, a data signal, or a combination power and data signal.

It will be appreciated that various changes and modifications can be made to the present invention without departing from the scope of the present application.

1. An electrical connector for engagement with a complementary connector,
the electrical connector comprising:
a first terminal;
an enclosure surrounding the first terminal;
a probe access port extending between an outer surface of the enclosure and the first terminal;
a conductive body disposed within the probe access port and moveable between a first position in which the conductive body is in electrical connection with the first terminal and a second position in which the conductive body is electrically disconnected from the first terminal, wherein the conductive body is biased towards the second position.

2. An electrical connector according to claim 1 comprising a seal disposed between the conductive body and the probe access port for preventing passage of liquid through the probe access port.

3. An electrical connector according to claim 1 comprising a biasing mechanism configured to bias the conductive body in the second position.

4. An electrical connector according to claim 1 comprising a cap to cover the probe access port at the outer surface of the enclosure.

5. An electrical connector according to claim 4 wherein the cap is biased into a closed position.

6. An electrical connector according to claim 1 wherein the conductive body has a proximal end adjacent the terminal and a distal end adjacent a probe-receiving aperture in the probe access port.

7. An electrical connector according to claim 1 wherein the probe access port comprises a plurality of seals.

8. An electrical connector according to claim 7 wherein a first seal is positioned adjacent the distal end of the conductive body and a second seal is positioned adjacent the proximal end of the conductive body.

9. An electrical connector according to claim 3 wherein the conductive body comprises an engagement component to engage the biasing mechanism.

10. An electrical connection between an electrical connector according to claim 1 and a second electrical connector that comprises a second connector terminal which is in electrical contact with the first terminal, wherein said electrical connection of the conductive body with the first terminal is through contact of the conductive body with the second connector terminal.

11. An electrical connector according to claim 1 comprising a plurality of first terminals, each one having its own probe access port.

12. A wiring harness comprising an electrical connector according to claim 11.

13. A vehicle comprising an electrical connector according to claim 1.
